(19) United States
(12) Patent Application Publication
(10) Pub. No.: US 2026/0053080 A1
(43) Pub. Date: Feb. 26, 2026

(54) Agricultural Implement Such As Mower Or Merger

(71) Applicant: PÖTTINGER Landtechnik GmbH, Grieskirchen (AT)

(72) Inventors: Andreas Dietachmair, Grieskirchen (AT); Florian Freimuller, Grieskirchen (AT); August Greifeneder, Grieskirchen (AT); Markus Reininger, Grieskirchen (AT)

(21) Appl. No.: 19/292,559

(22) Filed: Aug. 6, 2025

(30) Foreign Application Priority Data
Aug. 22, 2024 (DE) 10 2024 124 080.6

(51) Int. Cl. A01B 59/06; A01B 63/111

(52) U.S. Cl. CPC A01B 59/06; A01B 63/111

(57) ABSTRACT

An agricultural implement including a working assembly to be guided over the ground and a suspension for suspending the working assembly so as to be vertically movable during work operation. The suspension has a headstock attachable to a tractor or a frame connected to a tractor and a first steering assembly that protrudes from the headstock and forms a four-bar linkage that is pivotably mounted on the headstock by two joints and carries a second steering assembly, to which the working assembly is attached. The suspension has a relief device for weight relief of the working assembly, which includes a variable-length force transmitter in the form of a suspension strut and/or a pressure medium cylinder, wherein the force transmitter is installed on the first steering assembly under pressure.

### CROSS-REFERENCE TO RELATED APPLICATIONS

This application claims benefit under 35 USC § 119 of DE Application No. 10 2024 124 080.6 filed 22 Aug. 2024, which is incorporated herein by reference in its entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

### Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention relates to an agricultural implement for attaching to a tractor, in particular in the form of a mower or a merger, with a working assembly to be guided over the ground and a suspension for suspending the working assembly so as to be vertically movable during work operation, wherein the suspension has a headstock with attachment means for attaching to a tractor or a frame connected thereto and a first steering assembly, which protrudes from the headstock and forms a four-bar linkage which is mounted with two joints on the headstock and carries a second steering assembly to which the working assembly is attached, and with a relief device for weight relief of the working assembly, which includes a variable-length force transmitter in the form of a suspension strut or pressure medium cylinder.

### 2. Description of Related Art

Mowers or mergers are usually suspended so as to be vertically movable in order to achieve ground adaptation during work operation, so that the working assembly can lower itself into bumps into which the tractor has not yet driven or can avoid hills by an upward movement without the tractor itself having already driven onto the hill. In order to allow such height compensation movements in relation to the tractor during work operation, it is known to suspend the working assemblies of agricultural implements by means of one or more steering arrangements on a headstock, which can be mounted directly on the tractor, for example via a three-point suspension with upper and lower steering arms, which is known per se, which is done in particular with front-mounted front mowers or front harvesters. Alternatively, the headstock can also be attached to a machine frame, which in turn is then attached to the tractor, which is often done for rear-mounted rear mowers or rear harvesters, for example, in order to be able to guide the working assemblies protruding laterally to the right and left of the tractor.

Even if the headstock itself—for example via the three-point linkage—can be vertically movable relative to the tractor, for example in order to lift the working assembly for road transport, the vertical movability is effective in work operation relative to the headstock or, more precisely, between the working assembly and the headstock, in order to be able to drive the headstock at a fixed working height in work operation. The steering arrangements or groups, by means of which the working assembly is vertically movable relative to the headstock for ground adjustment, can, for example, first include a steering assembly which can form a four-bar linkage which protrudes from the headstock and is attached to the headstock with two joints so as to be movable about horizontal joint axes extending transversely to the direction of travel and can carry a suspension link with two further joints, which can itself form part of the four-bar linkage and carry a further suspension support.

The four-bar linkage configuration is usually visible when viewed with a viewing axis lying transverse to the direction of travel, wherein a pair of steering arms in the form of an upper steering arm and a lower steering arm protrude from the headstock and can be connected to one another by a connecting steering arm. However, it should be clarified that such a four-bar linkage can also comprise more than four joints, for example if double steering arms are used, and the steering arms of the four-bar linkage can be configured not only in the form of elongated struts, but also in the form of steering frames, for example in the form of bar supports or sheet metal chassis parts, so that, for example, a four-bar linkage with two joints can be attached to the headstock, which then form, for example, a joint axis or a joint point with a joint axis lying transverse to the direction of travel. It is also possible for the pair of steering arms to be configured differently in the form of an upper steering arm and a lower steering arm. For example, the upper steering arm can form an elongated strut and the lower steering arm can form a steering frame, so that spatially a triangular steering structure is formed in cross-section.

The working assembly can then be suspended from the first steering assembly, which forms the four-bar linkage protruding from the headstock, via a second steering assembly, which on the one hand can be attached to the first steering assembly, for example articulated, and on the other hand can be attached to the working assembly. The steering arms of this second steering assembly can also be configured in the form of elongated struts or also in the form of steering frames, wherein spatially arranged steering arms can also be provided here, for example with a central upper steering arm and two laterally offset lower steering arms. If necessary, the second steering assembly can also comprise only one steering arm, which can be rigidly attached to one of the steering arms of the four-bar linkage protruding from the headstock.

Regardless of the specific configuration of the steering assemblies, a relief device is usually provided for weight relief of the working assembly so that the working assembly does not have to stand on the ground with its full weight and, in particular, does not hit a mound of ground with the full inertia associated with the weight. The weight relief device reduces the ground contact pressure of the working assembly to allow the working assembly to move smoothly over hilly terrain with bumps and dips. Such relief devices may include force transmitters such as suspension struts or pressure medium cylinders that can lengthen and shorten to allow elevation movement of the working assembly while providing a relief force that compensates for at least a portion of the weight of the working assembly.

Such suspension struts can comprise mechanical springs, for example in the form of helical springs, or can also be configured pneumatically or hydraulically in the form of pressure medium cylinders, wherein the pressure medium cylinders can be supplied with pressure medium from pressure accumulators in order to enable shortening and elongation of the cylinder while simultaneously providing the relief force. Mixed forms of pressure medium cylinders and mechanical springs are also possible.

However, reducing the ground contact force during work operation not only improves ground adaptation and enables smooth up and down movements over bumps and dips, but also makes the working assembly easier to pull, i.e., the driving resistance is reduced, which improves the traction of the tractor and reduces the power requirement. At the same time, wear on the components due to ground contact can be reduced and the service life of the components increased. Less dirt build-up on the skids can, for example, improve the cutting quality of mowers and reduce the contamination of the crop in mergers, and the components are not subjected to as much stress. On the ground side, the advantage is that the sward is not damaged as much.

Irrespective of the specific configuration of the relief device, however, the ground contact force has so far varied relatively strongly between the highest headstock position and the lowest headstock position, wherein it is generally often the case with the relief systems available on the market to date that the working assembly rests much more lightly on the ground in the lowest position relative to the headstock, i.e., when the working assembly is retracted into a ground depression and lowered, i.e., has a significantly lower ground contact force than in the highest position, for example when the working assembly is raised to a higher elevation. This can mean that the working assembly does not fully enter the hollow in the ground and, for example, the cutting height at the bottom of the hollow increases slightly or the pick-up of a merger does not fully pick up the crop there. At the crest of hilltops or hills, the opposite effect can occur due to the lower relief there.

Such a conventional suspension of the working assembly with relief device is shown, for example, in EP 1593294B1, which has several steering assemblies that protrude from the headstock on the one hand and are arranged in opposite directions on the other, so that overall scissor-like steering movements result and, associated therewith, a favorable ground adaptation can be achieved. A tension spring is provided as a relief device between the headstock and the working assembly, which transfers the relief force directly to the working assembly.

Other suspensions for working assemblies of agricultural implements that are so as to be vertically movable during work operation are known, for example, from DE 4007735A1, DE 19624396A1 and US 5, 193,330A.

In view of the situation described, it is the underlying object of the present invention to create an improved agricultural implement of the type which avoids disadvantages of the prior art and further develops the latter in an advantageous manner. In particular, an improved vertical mobility of the working assembly during work operation is to be achieved, which allows a light-footed ground adaptation in hilly terrain with bumps and depressions without losing the ground contact by the working assembly, which is necessary for an efficient working result, in particular also when driving at higher driving speeds in more hilly terrain.

### BRIEF SUMMARY OF THE INVENTION

According to the invention, the problem is solved by an agricultural implement, in particular in the form of a mower or a merger, comprising a working assembly to be guided over the ground and a sus-pension for suspending the working assembly so as to be vertically movable during work operation, wherein the suspension has a headstock with attachment means for attaching to a tractor or a frame connect-ed thereto and a first steering assembly which protrudes from the head-stock and forms a four-bar linkage which is pivotably mounted on the headstock by two joints and carries a second steering assembly, to which the working assembly is attached, and also comprising a re-lief device for weight relief of the working assembly, which includes a variable-length force transmitter in the form of a suspension strut and/or a pressure medium cylinder, characterized in in that the force transmitter is installed on the first steering assembly under pressure in such a manner that the force transmitter becomes shortened when the first steering assembly is lowered and the lever arm of the force transmitter is reduced with respect to the four-bar linkage formed by the first steering assembly.

It is therefore proposed to install the force transmitter of the relief device on the four-bar linkage and to configure or arrange the four-bar linkage together with the force transmitter in such a manner that a change in the force provided by the force transmitter associated with a shortening and/or elongation of the force transmitter is at least partially compensated for by a changed lever arm of the force transmitter. According to the invention, the force transmitter of the relief device is installed on the four-bar linkage in such a manner that the force transmitter becomes shortened when the four-bar linkage lowers and the lever arm of the force transmitter is reduced when the four-bar linkage lowers.

This four-bar linkage and force transmitter arrangement is based on the consideration that in pressure medium cylinders which are pressurized from pressure accumulators, the pressure accumulators only have a limited volume and it is therefore often the case that the actuating force increases in the compressed state of the pressure medium cylinder, i.e., when this acts as a pressure force transmitter, and decreases when the cylinder elongates, wherein the strength of the changing actuating force can be subject to a linear increase or also an exponential increase towards the compressed position or a mixed form of such a linear and exponential increase. a mixed form of such a linear and exponential increase, wherein similar characteristics can also occur with mechanical suspension struts and, in particular, an increase in force can occur towards the fully compressed position. The two effects, i.e., an increase in the relief force and a reduction in the lever arm, can compensate each other to a certain extent in opposite directions due to a lever arm that simultaneously decreases as the force transmitter is shortened, especially towards the shortened end position, which corresponds to the lowest position of the working assembly.

According to one aspect of the invention, the arrangement and configuration of the force transmitter and four-bar linkage can be matched to one another in such a manner that the ground contact force of the working assembly remains at least approximately constant over the height adjustment region of the suspension. The progression of the actuating force of the force transmitter over its elongation/shortening or over its actuating travel is adapted to the geometry of the four-bar linkage formed by the first steering assembly in such a manner that the lever arm changes, so to speak, in mirror-image to the progression of the actuating force over the elongation/shortening of the force transmitter and mutual compensation takes place at least approximately completely.

In particular, the geometry of the four-bar linkage and the arrangement of the force transmitter and the actuating force characteristic of the force transmitter can be matched to one another in such a manner that the lever arm that the force transmitter has with respect to the four-bar linkage decreases accordingly when the actuating force of the force transmitter increases and, conversely, increases accordingly when the actuating force of the force transmitter decreases. For example, an at least approximately inverse proportionality can be provided between the progression of the lever arm and the progression of the actuating force via vertical movements of the four-bar linkage, more precisely via a pivot path of the four-bar linkage on which the force transmitter engages, and on the other hand via the actuating path of the force transmitter in the sense of an elongation/shortening of the force transmitter.

The change in the lever arm of the force transmitter can essentially be influenced or selected by selecting the pivot points of the force transmitter relative to the pivot points of the four-bar linkage, wherein the selection of the pivot points of the force transmitter relative to the four-bar linkage pivot points is also accompanied by a corresponding selection of the force transmitter length and the lengths of the steering arm.

The characteristic of the actuating force curve over the travel of the force transmitter can be set in various ways, for example by several and/or differently configured pressure accumulators if the force transmitter comprises a pressure medium cylinder or several and/or different mechanical springs if the force transmitter comprises a suspension strut, wherein pressure accumulators and mechanical springs can also be combined in order to achieve a desired actuating force characteristic.

For example, differently “hard” pressure accumulators can be connected in parallel or in series to act on the pressure medium cylinder, so that in a travel range in which only a smaller part of the pressure medium is displaced from the pressure medium cylinder, the pressure medium cylinder only has to work against the softer pressure accumulator in order to displace further pressure fluid. When the softer accumulator reaches its stop or capacity limit, further pressure medium can be displaced from the pressure medium cylinder into the harder accumulator, resulting in a corresponding, sectionally different actuating force characteristic, i.e., actuating force over travel. Similarly, a suspension strut can include various mechanical springs, for example connected in series or in parallel, with different springs being active in different travel ranges, for example via stops that limit the spring travel or drivers that only take a spring along when a predetermined travel is reached and then further travel.

In a similar manner, a pressure medium cylinder can also be coupled with a mechanical spring in such a manner that, for example, a mechanical spring also acts on the piston or between the piston and cylinder towards the end of the pressure medium cylinder's travel in order to provide an additional actuating force.

In order to achieve a favorable force flow with a compact design at the same time, the force transmitter can, in an advantageous further development of the invention, be supported directly on the headstock on the one hand and, on the other hand, be supported in the region of a joint on the protruding end portion of the four-bar linkage formed by the first steering assembly. In particular, the force transmitter can be supported directly at the pivot point of the four-bar linkage at its protruding end so as not to subject the four-bar linkage arms to bending stresses. Nevertheless, it would be possible to support the force transmitter on one of the steering arms rather than on a four-bar linkage. Due to the articulation of the force transmitter at the outer end portion of the four-bar linkage, the force transmitter undergoes a relatively strong change in its direction of action when the first steering assembly moves relative to the headstock so as to be vertically movable.

In a further development of the invention, the force transmitter and one of the steering arms of the first steering assembly can together form a two-position linkage which is articulated to the headstock. This two-position linkage would be rigid in itself if the force transmitter could not be lengthened or shortened. However, as the force transmitter is variable-length, the two-position linkage and thus the steering arm of the four-bar linkage can pivot, forcing elongation/shortening of the force transmitter.

Advantageously, the arrangement of this two-position linkage can be such that the force transmitter and the steering arm are inclined at an acute angle of less than 45° to each other in each height position of the suspension, wherein the acute angle between the force transmitter and the steering arm of the two-position linkage can also be less than 30° over the entire height adjustment travel of the suspension. Such a fairly acute angle does justice to the often only small change in the force curve of the force transmitter over its elongation/shortening and provides a correspondingly smaller change in the lever arm, which can at least approximately compensate for the change in actuating force.

In particular, the force transmitter can be installed between an upper steering arm and a lower steering arm of the first steering assembly, wherein the upper and lower steering arms protrude from the headstock and can be hingedly attached thereto. The force transmitter can have a pivot point on the headstock, which can lie between the pivot points formed by the joints of the two the upper and lower steering arms on the headstock. If the first steering assembly is configured with a double core or provided with a steering frame so that lateral, right and left offset handlebar parts are provided and are hingedly mounted on the linkage bracket, the force transmitter can be positioned centrally between these lateral steering parts, so that the pivot point of the force transmitter on the headstock does not lie vertically between the pivot points of the lower and upper steering arms, but is nonetheless arranged between them in terms of height, which can be seen when the suspension is viewed lying in a direction of view transverse to the direction of travel.

Advantageously, the force transmitter can have a force transmitter length that is smaller than either of the two steering arm lengths of the steering arms protruding from the headstock of the first steering assembly. As a result, there can be achieved an overall compact design, wherein at the same time a sufficient change in the direction of action of the force transmitter and thus the size of the lever arm can be achieved in order to be able to compensate for any increases in the actuating force towards one end of the travel.

In a further development of the invention, the first steering assembly can form at least approximately a parallelogram steering arrangement, wherein the protruding length of the steering assembly away from the headstock can be significantly greater than the distance between the articulation points of the first steering assembly on the headstock. For example, the lower and upper steering arms the above can have a handlebar length that can be two to three times the distance between the pivot points of the upper and lower steering arms on the headstock.

For example, the length of the force transmitter can be in the region of 50% to 90% or 60% to 75% of the steering arm length of the shorter of the two the upper and lower steering arms.

In an advantageous further development of the invention, the second steering assembly, which is articulated to the protruding end of the first steering assembly and carries the working assembly, can extend from the protruding end of the first steering assembly back towards the headstock, so to speak, wherein the second steering assembly can extend downwards from the protruding end portion of the first steering assembly to the working assembly. If, for example, the first steering assembly for a front mower or a front harvester protrudes forwards from the headstock in the direction of travel, the second steering assembly can extend backwards at an angle to the rear/downwards against the direction of travel. Conversely, if the first steering assembly protrudes from the headstock against the direction of travel, the second steering assembly can have a progression that slants downwards towards the front.

Irrespective of the counter-rotation of the two steering assemblies, the second steering assembly can be configured to be spatially movable and enable the working assembly to make spatially luffing or rotating movements about a horizontal luffing axis pointing approximately in the direction of travel and/or about an upright axis. For example, the second steering assembly can be configured to enable the working assembly to perform luffing movements in which the right and left wing portions of the working assembly move up and down in opposite directions. If the working assembly tilts in such a manner that, for example, a left end portion moves upwards, a right end portion can move downwards.

Alternatively, or additionally, the second steering assembly can enable the working assembly to rotate about an upright axis in such a manner that left and right wings or end portions of the working assembly can pivot forwards and backwards in opposite directions to one another, for example in such a manner that a right end portion pivots forwards when a left end portion pivots backwards.

In particular, the second steering assembly can combine the luffing and pivoting movements in such a manner that an upwardly luffing wing or end portion of the working assembly simultaneously pivots a little backwards and, conversely, a downwardly luffing end portion simultaneously rotates a little forward. By configuring the spatially movable second steering assembly in this manner, an even better adaptation to the ground can be achieved. In particular, any terrain copying that only occurs on one side of the machine can be better absorbed or compensated for by ground adaptation movements. If, for example, a contour elevation occurs in the tramline on the right half of the machine, the right end portion of the working assembly can pivot upwards and backwards, which can be compensated for by the left end portion of the working assembly with a pivoting movement downwards and forwards. This allows the working assembly to react less sluggishly overall and therefore faster.

In a further development of the invention, the second steering assembly can include a central carrier steering arm, which can be articulated approximately centrally on the working assembly, and in particular can form a central suspension articulation point for the working assembly. For example, the pivot point between this central carrier steering arm and the working assembly can pivot in a multi-axis ball-joint-like manner so that the working assembly is suspended in a balanced manner on the central carrier steering arm. If the working assembly has an eccentric or asymmetrical center of gravity, for example as a result of off-center attachments such as gearboxes or side shields, the pivot point of the central carrier steering arm can also be shifted accordingly eccentrically in order to lie essentially above the center of gravity of the working assembly. The pivot point of the central carrier steering arm can of course also be positioned essentially above the center of gravity of the working assembly when the center of gravity is central or not eccentric.

The second steering assembly can further comprise two lateral control arms, which can be hingedly attached eccentrically to the right and left of the working assembly at a spaced apart distance, wherein the lateral control arms can also be articulated multi-axially to the working assembly.

On the other hand, the lateral control steering arms can be hingedly attached to the first steering assembly or to a bracket part connected thereto, wherein the distance between the pivot points of the control arms on the working assembly side and the distance between the pivot points of the control arms on the four-bar side can be essentially the same, so that the control arms can extend essentially parallel to one another in upright planes parallel to the direction of travel in an undeflected neutral position of the working assembly.

The central carrier steering arm can be positioned essentially centrally between the two lateral control steering arms or, in an undeflected neutral position of the working assembly, can extend in an upright plane parallel to the direction of travel, which lies between the two the planes in which the lateral control steering arms extend.

The pivot points of the steering arms of the second steering assembly on the four-bar linkage side and on the working assembly side can advantageously lie at different heights and/or be spaced apart in the direction of travel, so that the steering arms are spatially movable in the manner, but on the other hand hold the working assembly at a predetermined height, which is determined by the position of the four-bar linkage formed by the first steering assembly.

For example, the steering arms of the second steering assembly can form a three-point linkage comprising an upper steering arm and two lateral lower steering arms or a lower steering arm and two lateral upper steering arms.

In a further development of the invention, an agricultural implement comprises a working assembly configured to be vertically movable through height positions and guided over ground during a work operation, and a suspension configured to suspend the working assembly, wherein the suspension comprises a headstock configured to be attached to a tractor or a frame connected to the tractor, a first steering assembly that protrudes from the headstock and forms a four-bar linkage that is pivotably mounted to the headstock at a first joint and at a second joint, a second steering assembly to which the working assembly is attached, and a relief device configured for weight relief of the working assembly, the relief device comprises a variable-length force transmitter configured to elongate/shorten, and the force transmitter is of variable-length via being under pressure in such a manner that the force transmitter shortens when the first steering assembly is lowered and a lever arm of the force transmitter is reduced with respect to the four-bar linkage formed by the first steering assembly.

The force transmitter can be located between an upper steering arm of the first steering assembly pivotably mounted to the headstock at the first joint and a lower steering arm of the first steering assembly pivotably mounted to the headstock at the second joint.

The force transmitter can have a pivot point relative the headstock at a third joint that lies between the first joint and the second joint.

The force transmitter and the first steering assembly can be configured and arranged in such a manner that the relief device provides at least approximately constant weight relief over a height adjustment region of the suspension, and/or a ground contact force of the working assembly that remains at least approximately constant over the height adjustment region of the suspension.

The second steering assembly can comprise a central carrier steering arm that at one end is articulated to the working assembly and, at another end, is articulated to a protruding end portion of the first steering assembly.

The force transmitter can be supported at one end in an articulated manner to the headstock and at another end in the region of a fourth joint on a protruding end portion of the first steering assembly.

The force transmitter and an upper steering arm of the first steering assembly together can form a two-position linkage articulated to the headstock at the first joint and a third joint that lies between the first joint and the second joint.

The force transmitter and the upper steering arm can be inclined to one another at an acute angle α of <45° in each of the height positions of the suspension.

The first steering assembly can form at least approximately a trapezoidal steering arrangement.

The second steering assembly can form a three-point steering arrangement that suspends the working assembly from a protruding end portion of the first steering assembly.

The second steering assembly can be configured to be spatially movable and provide for spatially pivoting movements of the working assembly relative to the first steering assembly about a horizontal pivoting axis pointing in a direction of travel and/or about an upright pivoting axis.

The force transmitter can comprise a pressure medium cylinder that is pressurized from two or more differently configured pressure accumulators connected in series or in parallel in such a manner that a different pressure is switched to the pressure medium cylinder in different longitudinal positions of the pressure medium cylinder.

The force transmitter can comprise at least one suspension strut having differently configured springs that are active in different length position regions of the suspension strut.

The force transmitter can have a force transmitter length that is smaller than both a length of the upper steering arm and a length of the lower steering arm.

The geometries of the first steering assembly and the force transmitter can be matched to one another in such a manner that a progression of a force provided by the force transmitter over its elongation/shortening is at least approximately a mirror-image to a change in the lever arm, which the force transmitter has with respect to the four-bar linkage formed by the first steering assembly, over a pivot path of the four-bar linkage, which is associated with the elongation/shortening of the force transmitter.

The second steering assembly can further comprise two lateral control steering arms that at one end are articulated in a spaced apart manner to the working assembly and, at another end, are articulated to the protruding end portion of the first steering assembly.

The central carrier steering arm and the two lateral control steering arms can each be hingedly attached to the working assembly and on the protruding end portion of the first steering assembly.

The central carrier steering arm and the two lateral control steering arms can be arranged in such a manner that the working assembly is configured to be luffed up from a horizontal neutral position about a horizontal axis pointing in a direction of travel relative to the first steering assembly and/or configured to be moved up and down with right and left end portions in opposite directions to one another.

The second steering assembly can be configured in such a manner that the working assembly can be moved up and down with lateral, right and left end portions in opposite directions and at the same time can be moved forwards and backwards in opposite directions in the direction of travel.

An upward movement at a lateral end portion of the second steering assembly can be associated with a backward movement against the direction of travel of the lateral end portion relative to the first steering assembly.

These and other objects, features and advantages of the present invention will become more apparent upon reading the following specification in conjunction with the accompanying drawing figures.

### BRIEF DESCRIPTION OF THE DRAWINGS

The invention is explained in more detail below with reference to advantageous embodiments and the corresponding drawings. The drawings show:

FIG. 1 is a side view of an agricultural implement according to an advantageous embodiment of the invention, which is attached to the front of a tractor and configured as a mower.

FIG. 2 is a plan view of the implement from FIG. 1.

FIG. 3 is a side view of the implement in a medium height position of the suspension.

FIG. 4 is a plan view of the implement from FIG. 3.

FIG. 5 is a side view of the implement in a lowered height position of the suspension, for example when driving through a depression in the ground.

FIG. 6 is a side view of the implement from the previous figures in a raised height position of the suspension, for example when driving over a terrain elevation.

FIG. 7 is a side view of the implement from the previous figures in a middle height position of the suspension.

FIG. 8 is a side view of an implement according to a further embodiment of the invention, in which the force transmitter of the relief device is no longer supported directly on the headstock, but on one of the steering arms of the first steering assembly.

FIG. 9 is a side view of a further embodiment of the invention, in which the force transmitter is no longer articulated directly to a pivot point of the four-bar linkage formed by the first steering assembly at its protruding end portion, but to an upper steering arm of the four-bar linkage.

FIG. 10 is a plan view of the implement similar to FIG. 4, wherein the working assembly and associated second steering assembly are shown in a spatially pivoted position in plan view.

FIG. 11 is a perspective view of the working assembly in the spatially pivoted position of the working assembly shown in FIG. 10.

FIG. 12 is a front view of the working assembly with spatially pivoted working assembly and spatially pivoted second steering assembly.

FIG. 13 is a graphic representation of the ground contact force of the working assembly of the implement from the previous figures over the various height positions of the suspension, with a solid line representing a front mower with conditioner and a dashed line representing a front mower without conditioner.

FIG. 14 is a graphic representation of the ground contact force over the various height positions of the suspension, wherein an embodiment of the invention is shown with a solid line and the ground contact force of a conventional prior art implement is shown with a dashed line.

FIG. 15 is a graphic representation of the ground contact force over various height positions of the suspension, wherein an embodiment of the invention is again shown with a solid line and, for comparison, another conventional implement according to the prior art is shown with a dashed line.

FIG. 16 is a perspective view of an implement according to a further embodiment of the invention, comprising two mechanical suspension struts as force transmitters.

FIG. 17 is a plan view of the implement shown in FIG. 16.

FIG. 18 is a force-travel diagram of the force transmitter of the relief device, which shows the actuating force of the force transmitter dependent on the elongation/shortening of the force transmitter.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

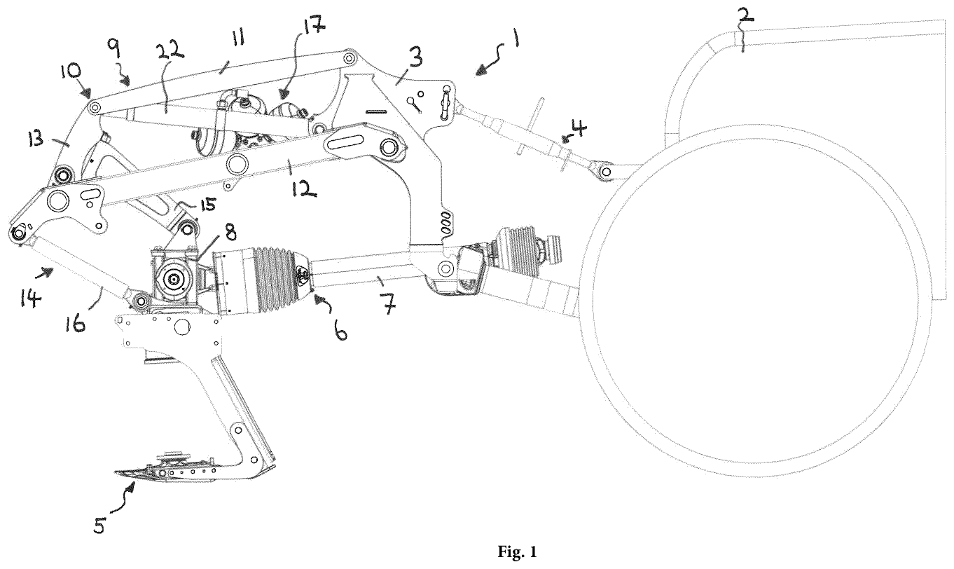

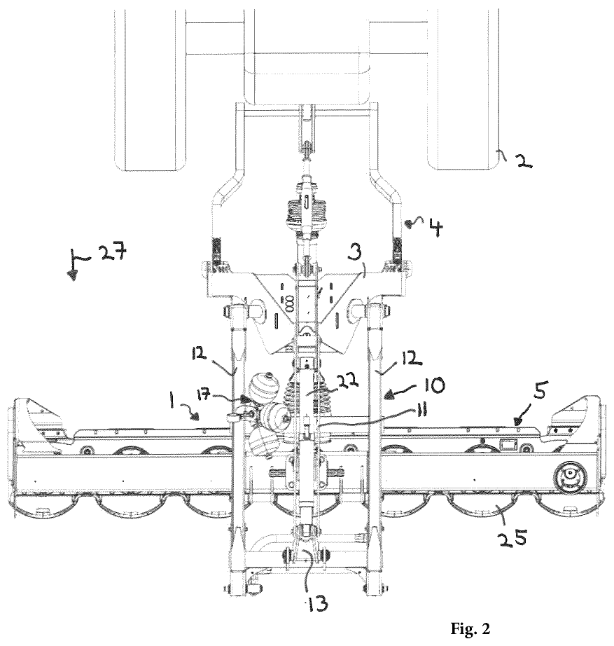

As shown in FIGS. 1 and 2, the agricultural implement 1 can be attached to a tractor 2 by means of a headstock 3, wherein the headstock 3 can, for example, be attached to the tractor 2 via a three-point linkage 4 with an upper steering arm and two lower steering arms, cf. FIGS. 1 and 2.

The suspension 9 for the working assembly 5 comprises two steering assemblies 10 and 14, by means of which the working assembly 5 is mounted on the headstock 3 so as to be vertically movable, so that the working assembly 5 can move up and down relative to the headstock 3 during work operation, as will be explained in more detail.

The working assembly 5 can comprise a cutter bar 25 when the implement 1 is configured as a mower, the cutters of which can be rotationally driven in a manner known per se, for example by means of a drive train 6 from the tractor 2, which can comprise a cardan shaft 7 and a transmission 8 on the working assembly 5 in order to be able to introduce the drive movement into the cutter discs. If the implement 1 is configured as a merger, the working assembly 5 can comprise a pick-up with a spiked roller that can be driven in rotation, wherein, here too, a drive train can be driven from the tractor.

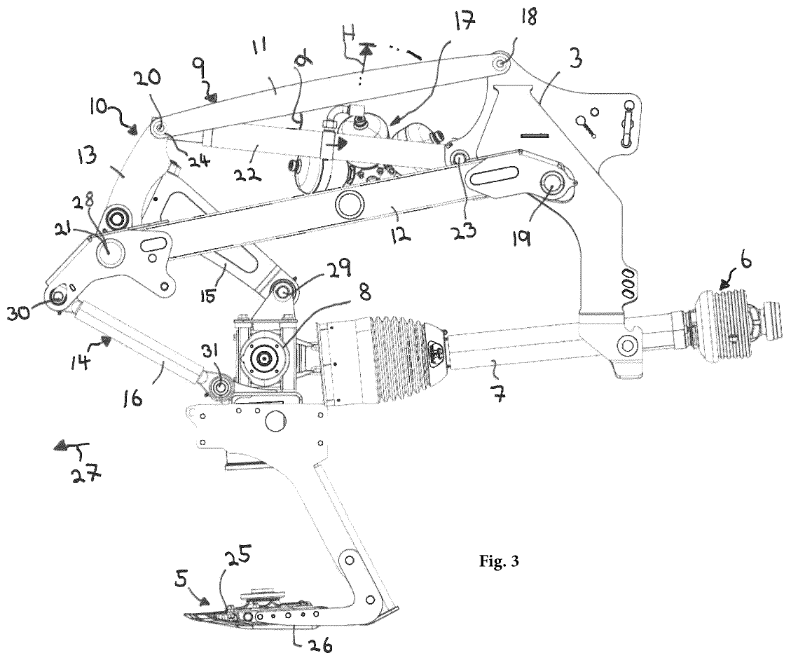

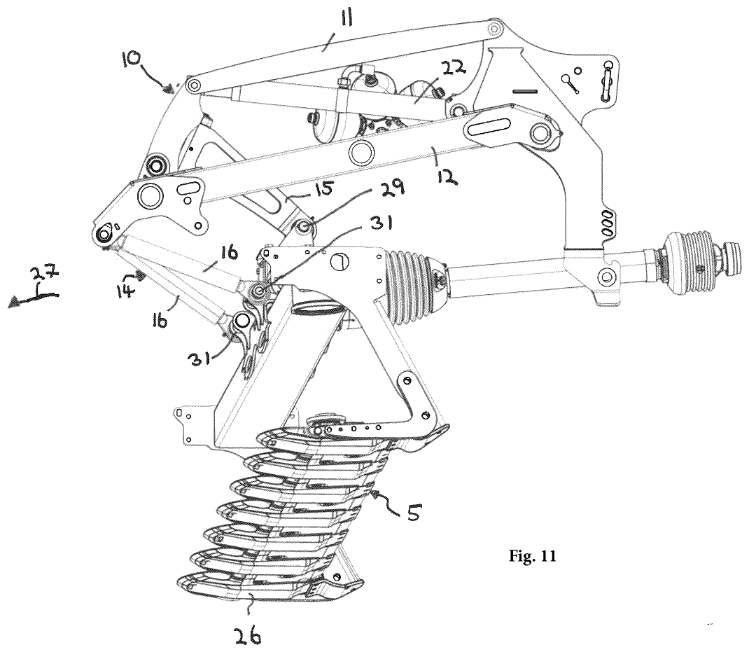

Regardless of the specific configuration of the working assembly 5, the latter can be supported on the ground by means of skids 26, sliding plates and/or feeler wheels in order to be able to follow ground contours, cf. FIG. 3 and FIG. 11.

As shown in FIG. 3, the suspension 9 can comprise a first steering assembly 10, which can form a four-bar linkage protruding from the headstock 3, wherein, depending on the mounting situation, a forward protrusion in the direction of travel or a rearward protrusion against the direction of travel 27 can be provided.

The first steering assembly 10 may comprise an upper steering arm 11 and a lower steering arm 12, each of which may be hingedly attached to the headstock 3 by means of a joint 18 and 19 respectively, wherein the joints 18 and 19 may have horizontal hinge axes transverse to the direction of travel 27.

The upper and lower steering arms 11 and 12 can be connected to one another at their protruding end portions facing away from the headstock 3 by means of a connecting steering arm 13, wherein the connecting steering arm 13 can be hingedly attached to the steering arms 11 and 12 by two joints 20 and 21. The joints 20 and 21 can also form horizontal joint axes transverse to the direction of travel.

As FIG. 3 and FIGS. 5 to 9 show, the upper and lower steering arms 11 and 12 can pivot around the horizontal or have a pivoting range that includes the horizontal, whereby the steering arms 11 and 12 can project from the headstock 3 with a medium height position, for example, inclined downwards at a slight acute angle to the horizontal, cf. FIG. 3.

The steering arms 11, 12 and 13 can approximately form an elongate parallelogram steering arrangement, but preferably the steering arms 11, 12 and 13 form a steering arrangement deviating from a parallelogram, in particular a trapezoidal steering arrangement, in order to generate a pivoting movement of the connecting steering arm 13 when the first steering assembly 10 is pivoted, which can impart a slight pivoting movement to the working assembly 5 when the first steering assembly 10 is moved up and down.

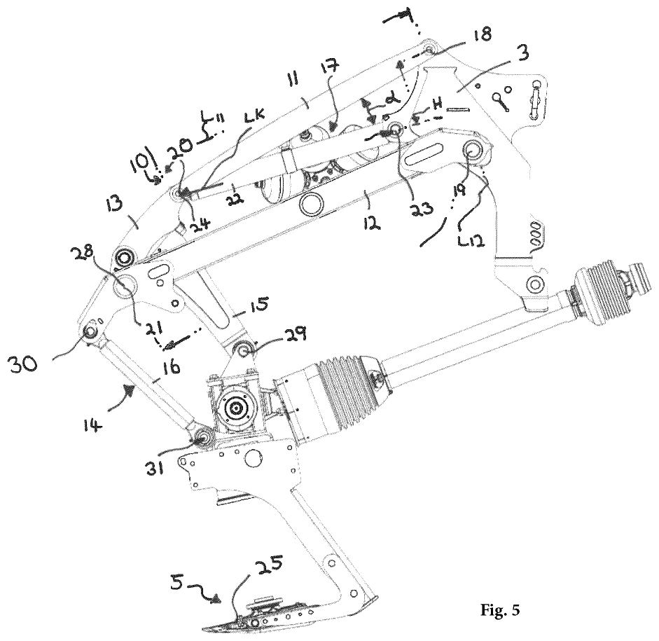

In particular, the upper and lower steering arms 11 and 12 can be configured with different lengths, wherein preferably the upper steering arm 11 can have a steering arm length L₁₁ that is shorter than the steering arm length L₁₂ of the lower steering arm 12, cf. FIG. 5.

Alternatively or additionally, the joints 18 and 19 of the first steering assembly 10 on the headstock 3 may have a distance from one another which corresponds approximately to the distance between the joints 20 and 21 of the first steering assembly 10 at its protruding end portion, wherein the distance between one pair of joints 18, 19 may, for example, be in the region of 80%-120% of the distance between the other pair of joints 20, 21.

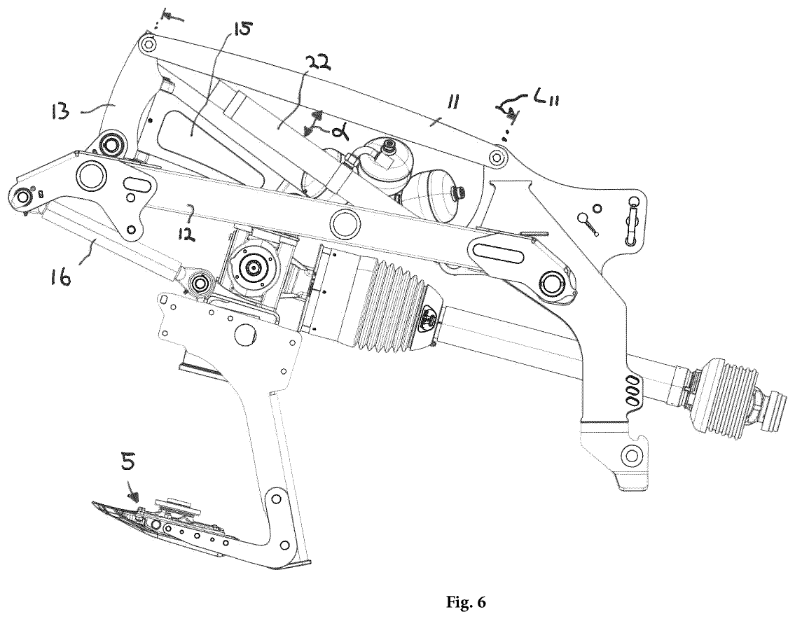

In particular, the first steering assembly 10 with its pivot points 18-21 can form a trapezoidal steering arrangement in order to generate a pivoting movement of the connecting steering arm 13 when the steering assembly 10 is hinged up and down relative to the headstock 3, which can in particular be oriented in such a manner that the working assembly tilts with a front edge upwards and a rear edge downwards in the case of an upward movement, cf. FIG. 6 and vice versa during a lowering movement with the front edge tilting downwards and the rear edge tilting upwards, cf. FIG. 5.

The working assembly 5 is therefore advantageously not simply moved up and down in a constant orientation, but is tilted slightly at the same time in order to get over the elevation more easily when driving up a hill or a terrain elevation and, conversely, to lower the front edge of the working assembly more quickly when driving down into a depression, cf. FIGS. 5-7 for comparison.

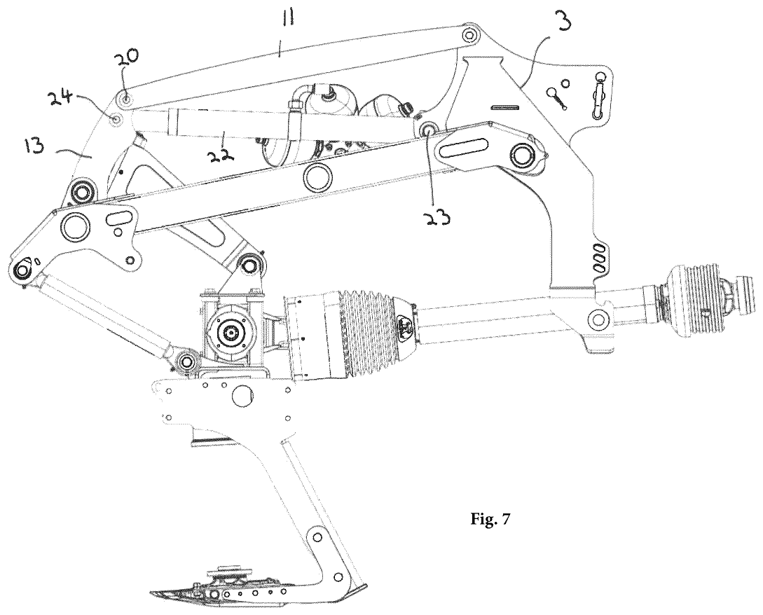

The working assembly 5 is suspended from the first steering assembly 10 by means of a second steering assembly 14, which may comprise a central carrier steering arm 15 and two lateral control steering arms 16, which are offset slightly to the right and left and which may be hingedly attached to the working assembly 5 on the one hand and to the protruding end portion of the first steering assembly 10 on the other hand. In this case, the central carrier steering arm 15 can be articulated centrally on the working assembly 5 or above the center of gravity of the working assembly 5 by means of a joint 29 on the working assembly 5, wherein the joint 29 can permit spatially pivoting movements in the manner of a ball-and-socket joint. The central carrier steering arm 15 can be articulated to the first steering assembly 10 by a joint 28, which can advantageously be provided on the connecting steering arm 13 or can engage on the joint 21 between the connecting steering arm 13 and the lower steering arm 12, cf. FIG. 7, wherein the joint 28 can also advantageously allow spatially pivoting movements of the central carrier steering arm 15 relative to the first steering assembly 10 in the manner of a ball joint. As FIG. 7 illustrates, the central carrier steering arm 15 may, at least in a central neutral position of the suspension 9, extend obliquely downwards from the protruding end portion of the first steering assembly 10 back towards the headstock 3. The joint 28 can be positioned higher than the joint 29 on the working assembly 5.

The laterally offset control steering arms 16 are each hingedly attached to the working assembly 5 by a joint 31 and are attached by means of a joint 30 to the protruding end portion of the first steering assembly 10, preferably to an end portion of the lower steering arm 12, which can protrude beyond the joint 21 of the connecting steering arm 13, cf. for example FIGS. 3 and 5 to 7. The joints 30 and 31 for articulating the control steering arms 16 can also permit spatially pivoting movements in the manner of a ball joint.

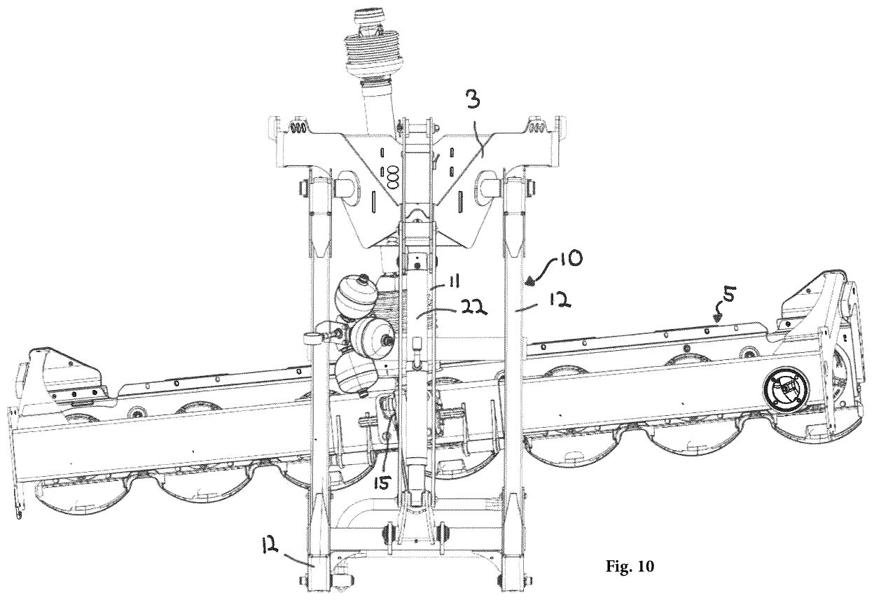

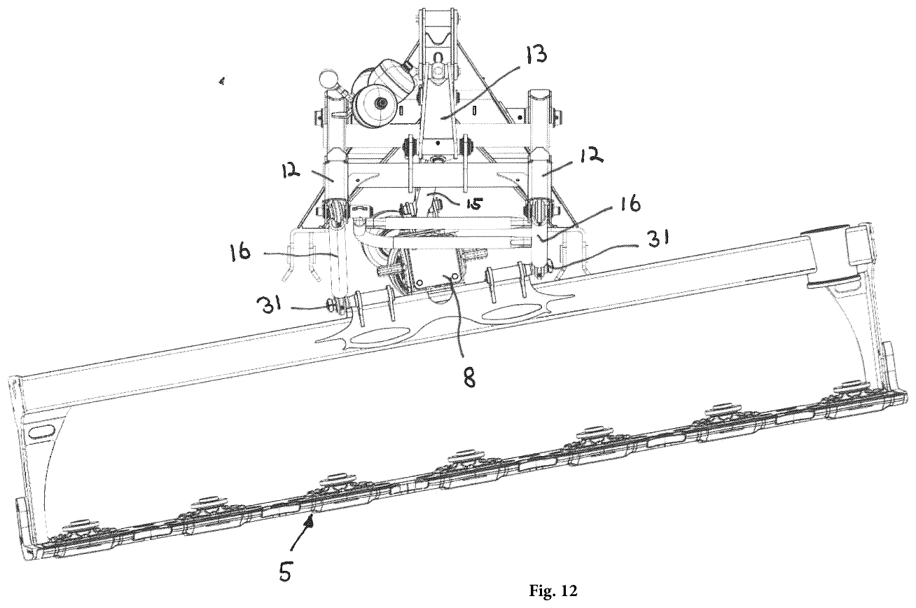

As FIGS. 10, 11 and 12 illustrate, the control steering arms 16 can be arranged parallel to one another at least in an undeflected neutral position and extend in upright planes parallel to the direction of travel, cf. FIG. 12, which however shows an interlocked position of the second control steering assembly 14, and FIG. 3, which shows the two control steering arms 16 concealed one behind the other. The central carrier steering arm 15 can be arranged centrally between the two control steering arms 16, at least in the undeflected neutral position of the suspension 9, and can be arranged higher in relation to the control steering arms 16, wherein the joints 28, 29 of the carrier steering arm 15 on the one hand and the joints 30, 31 of the control steering arm 16 on the other hand form a four-bar linkage when viewed lying transversely to the direction of travel 27, and can approximately define a parallelogram or a slight trapezoid, cf. FIG. 3.

As FIG. 3 shows, the joint 28 of the central carrier steering arm 15 can be mounted or supported on a cross member of the first steering assembly 10 in its protruding end region, wherein the joint 28 can have a horizontal joint axis oriented transversely to the direction of travel 27, which can be coaxial with the joint axis of the joint 21 which connects the lower steering arm 12 of the first steering assembly 10 to its connecting steering arm 13, cf. FIGS. 3 and 5. If necessary, the joint 28 can also be supported directly on the joint 21 or be combined therewith. Alternatively, however, the carrier steering arm 15 with the joint 28 can also be positioned on the connecting steering arm 13 slightly above the lower joint 21 of the connecting steering arm 13, so that the pivot point of the carrier steering arm 15 moves as a result of the pivoting of the connecting steering arm 13, which occurs when the first steering assembly 10 is hinged and unhinged relative to the lower steering arm 12 and thus relative to the joint 30 of the control steering arm 16. This displacement or movement of the joint 28 of the central carrier steering arm 15 relative to the joint 30 of the control steering arm 16 can contribute to the previously described tilting movements of the working assembly 5 during up and down movements, as illustrated by FIGS. 5-7 in comparison with one another.

As FIG. 3 further shows, the steering arms 15, 16 of the second steering assembly 14 can be configured to be significantly shorter than the steering arms 11 and 12 of the first steering assembly 10 and, for example, have a length in the region of 30% to 80% or 40% to 60% of the steering arm lengths L₁₁, L₁₂, cf. FIGS. 3 and 5.

In particular, the upper and lower steering arms 11 and 12 of the first steering arm assembly 10 can protrude beyond the working assembly 5 from the headstock 3. Due to the slightly downward extension of the steering arms 15, 16 of the second steering assembly 14 in opposite directions, the working assembly 5 can be guided at a distance from the headstock 3 below the first steering assembly 2, cf. FIGS. 3 and 5 to 7.

As FIGS. 10 to 12 illustrate, the steering arms 15, 16 of the second steering assembly 14 form a three-point linkage for the working assembly 5 on the first steering assembly 10, wherein the second steering assembly 14 is configured to be spatially pivotable in multiple axes and permits or controls multi-axis pivoting movements of the working assembly 5 relative to the first steering assembly 10 and thus also relative to the headstock 3. In particular, the second steering assembly 14 is configured in such a manner that the working assembly 5 can perform rotary movements about an upright pivot axis, which can be arranged in the region of the central carrier steering arm 15, so that a right end portion and a left end portion of the working assembly 5 can pivot forwards and backwards in opposite directions to one another in the direction of travel, cf. FIG. 10.

On the other hand, the second steering assembly 14 provides for a pivotability of the working assembly 5 about a horizontal luffing axis pointing in the direction of travel, which can extend in the region between the steering arms 15 and 16 of the steering assembly 14, cf. FIG. 12.

In particular, the steering assembly 14 can couple these two pivoting movements about the horizontal pivoting axis parallel to the direction of travel and the upright pivoting axis with one another or pivot the working assembly 5 in such a manner that both pivoting movement portions are executed simultaneously, and in particular in such a manner that an upwardly pivoting end portion of the working assembly 5 simultaneously pivots rearwardly and a downwardly pivoting end portion simultaneously pivots forwardly, cf. FIGS. 10 to 12 for comparison.

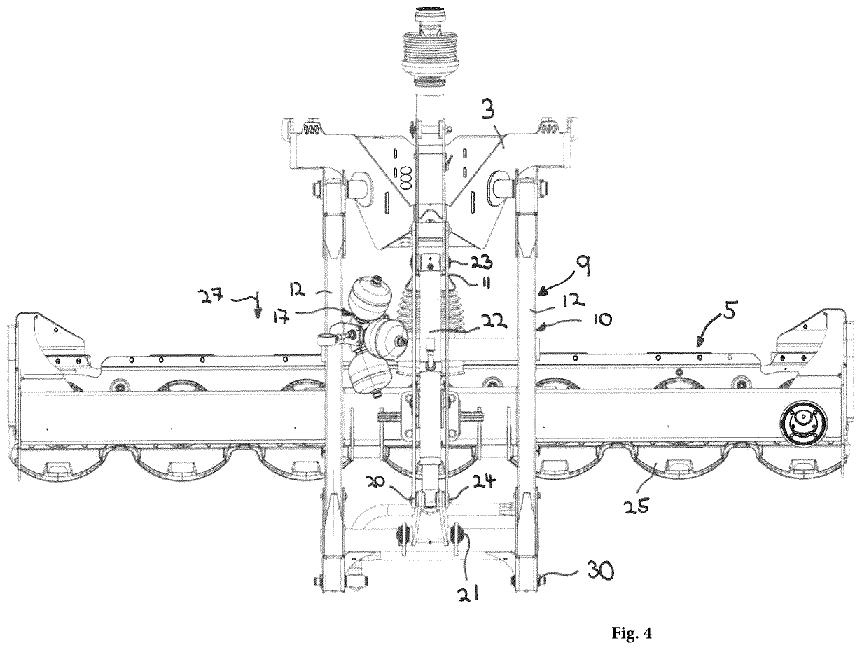

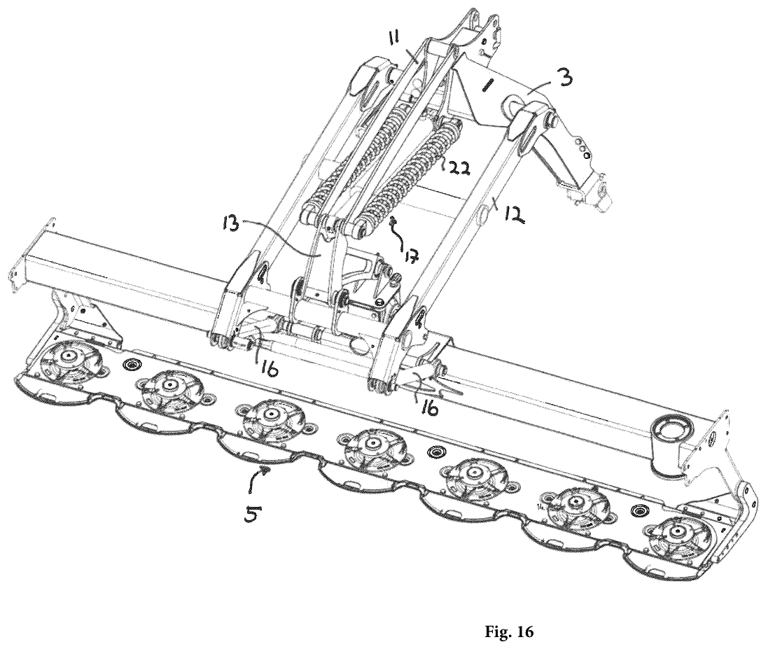

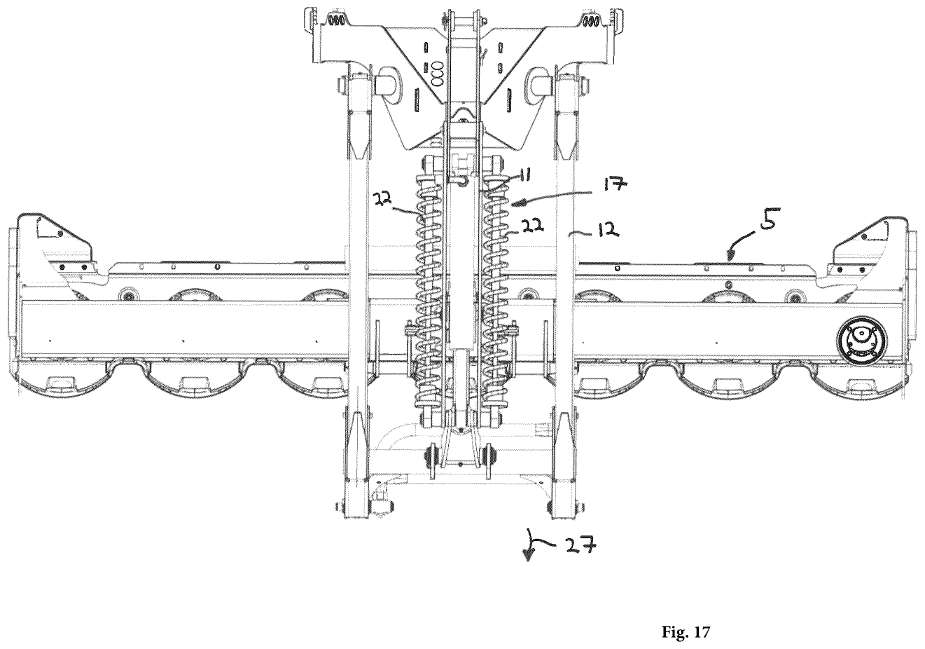

A relief device 17 is provided for weight relief of the working assembly 5, which comprises a force transmitter 22, which can comprise a pressure medium cylinder, which can be configured to be single-acting, cf. FIGS. 1-12. Alternatively, or additionally, the force transmitter 22 can also comprise a mechanical suspension strut, cf. FIGS. 16 and 17.

Irrespective of the configuration of the force transmitter 22 as a pressure medium cylinder or mechanical suspension strut, the force transmitter 22 can comprise several pressure medium cylinders or suspension struts connected in parallel next to each other, cf. FIGS. 16 and 17, wherein mixed forms of pressure medium cylinders and mechanical suspension struts are also possible.

As FIG. 3 shows, for example, a force transmitter 22 configured as a pressure medium cylinder can be pressurized from several pressure accumulators 32, which can be arranged in parallel or connected in series with one another with regard to the summation of the individual pressurized fluid flows.

Advantageously, the force transmitter 22 is installed on the first steering assembly 10 and is installed in such a manner that it is subjected to pressure or becomes shortened when the first steering assembly 10 is lowered relative to the headstock 3.

In particular, the force transmitter 22 can be supported directly on the headstock 3 by a joint 23 on the one hand and supported on a protruding end portion of the steering arm group 10 by a joint 24 on the other hand, in particular on the upper joint 20 of the connecting steering arm 13 with the upper steering arm 11.

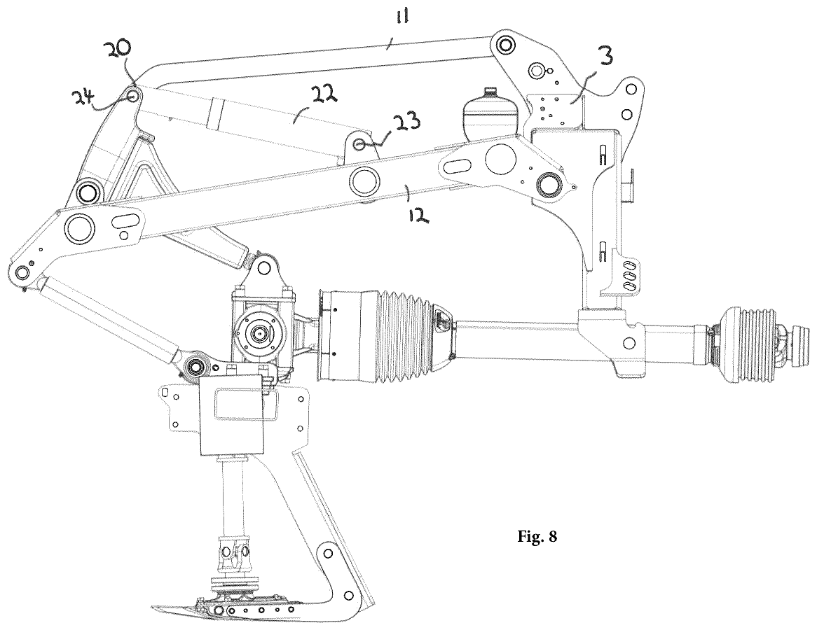

Alternatively, however, the force transmitter 22 can also be supported on one of the steering arms of the first steering assembly 10, in particular on the lower steering arm 12, and preferably in the half of the lower end 12 that is closer to the headstock 3, cf. FIG. 8.

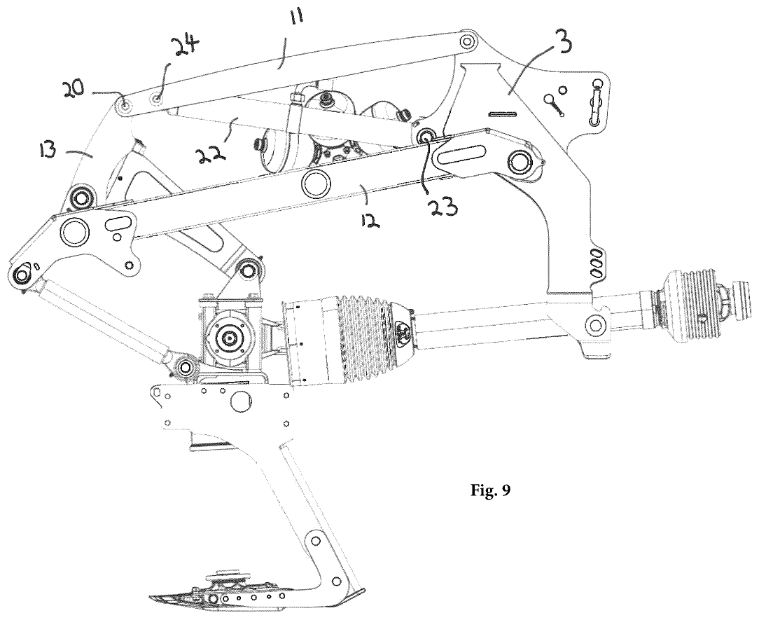

Alternatively, or additionally, the force transmitter 22 can also be articulated with its other pivot point 24 to one of the steering arms of the first steering assembly 10, in particular to the connecting steering arm 13, preferably still in the vicinity of the joint 20 between the connecting steering arm 13 and the upper steering arm 11, cf. FIG. 7. Alternatively, the force transmitter 22 can also be articulated with its pivot point 24 to the upper steering arm 11 itself, preferably in the vicinity of the joint 20 between the upper steering arm 11 and the connecting steering arm 13, cf. FIG. 9.

Preferably, the force transmitter 22 may extend diagonally within the four-bar linkage formed by the first steering assembly 10.

In particular, the force transmitter 22 can form a two-position linkage with one of the steering arms of the first steering assembly 10, for example the upper steering arm 11, which is articulated to the headstock 3, cf., for example, FIG. 1 and FIG. 3.

According to the proposed installation situation of the force transmitter 22, the force transmitter 22 becomes shortened when the first steering assembly 10 moves downwards and, conversely, elongated when the steering assembly 10 moves upwards.

Advantageously, the geometry of the steering assembly 10 and the pivot points of the force transmitter 22 formed by the respective joints on the one hand and the steering arms 11, 12, 13 on the other hand is in such a manner that the lever arm H of the force transmitter 22 decreases with respect to the four-bar linkage formed by the first steering assembly 10 when the force transmitter 22 shortens or when the first steering assembly 10 moves downwards, cf. comparative FIG. 3 and FIG. 5.

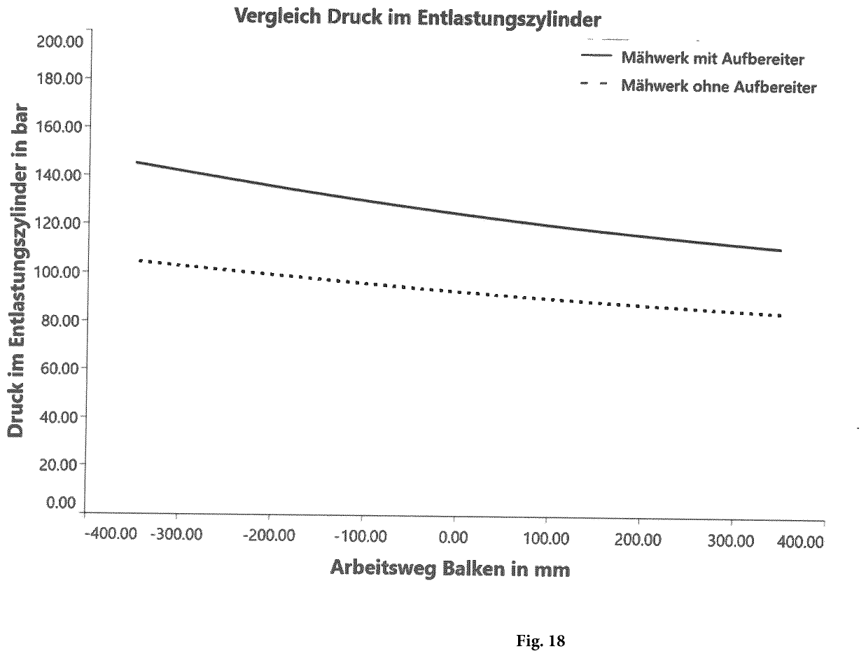

The force provided by the force transmitter 22 for weight relief can change over the compression or the travel of the force transmitter 22, in particular increase when the force transmitter 22 is shortened. For example, an approximately linear increase in the force provided can be provided as the force transmitter 22 becomes increasingly shorter, as illustrated in FIG. 18, possibly with a slightly exponential increase towards the shortened end position of the force transmitter 22.

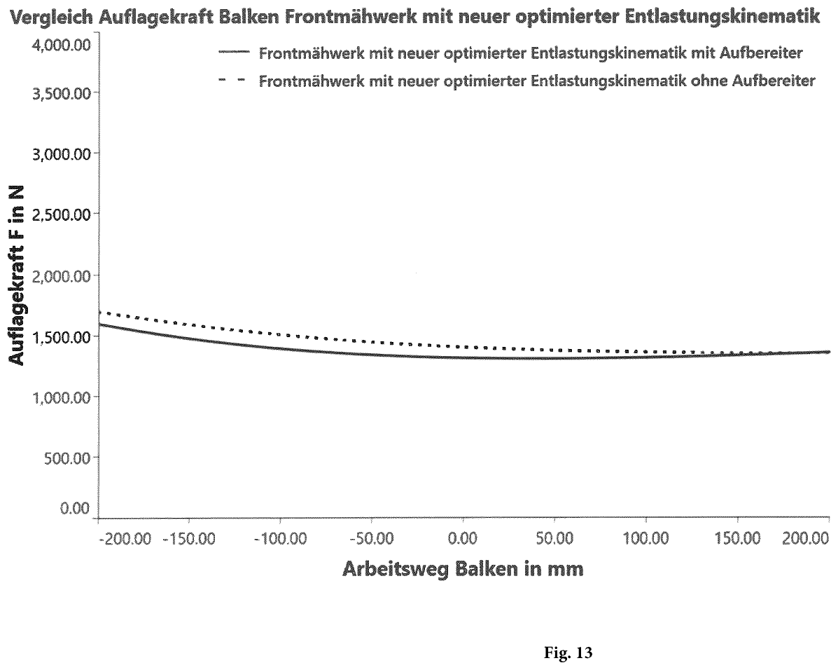

The two characteristics, i.e., an actuating force that increases when the force transmitter 22 is shortened on the one hand and a reduction in the lever arm that occurs when the force transmitter 22 is shortened due to a downward movement of the suspension 9, a certain combination of the two effects can be achieved and a ground contact force of the working assembly 5 that remains constant at least approximately and/or over a larger region of the height adjustment travel of the suspension 9 can be achieved, as illustrated in FIG. 13, which shows the contact force of a working assembly 5 in the form of a cutter bar with dashed lines and the ground contact force of a working assembly 5 in the form of a cutter bar with an additional conditioner with a solid line. Only towards the lowest position of the suspension 9 is there an increasing slight increase in the contact force, while over long distances an at least approximately constant contact force is achieved.

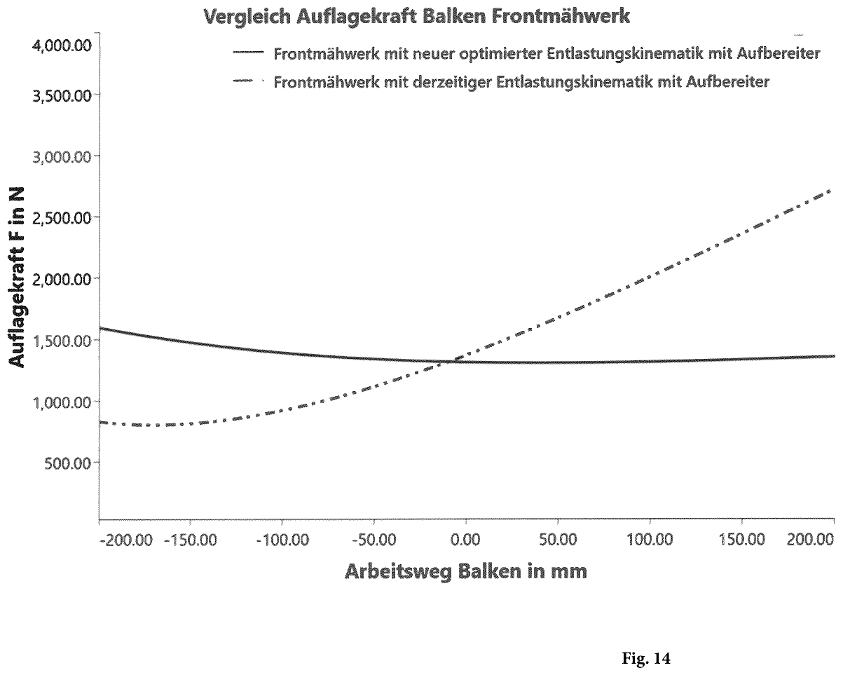

FIG. 14 shows the approximately constant ground contact force-shown with a solid line compared to the ground contact force of a prior art device, which is shown in dashed lines in FIG. 14 and shows the known effect that the ground contact force decreases significantly when driving downwards into a depression in the ground and, conversely, increases significantly when driving up a hill.

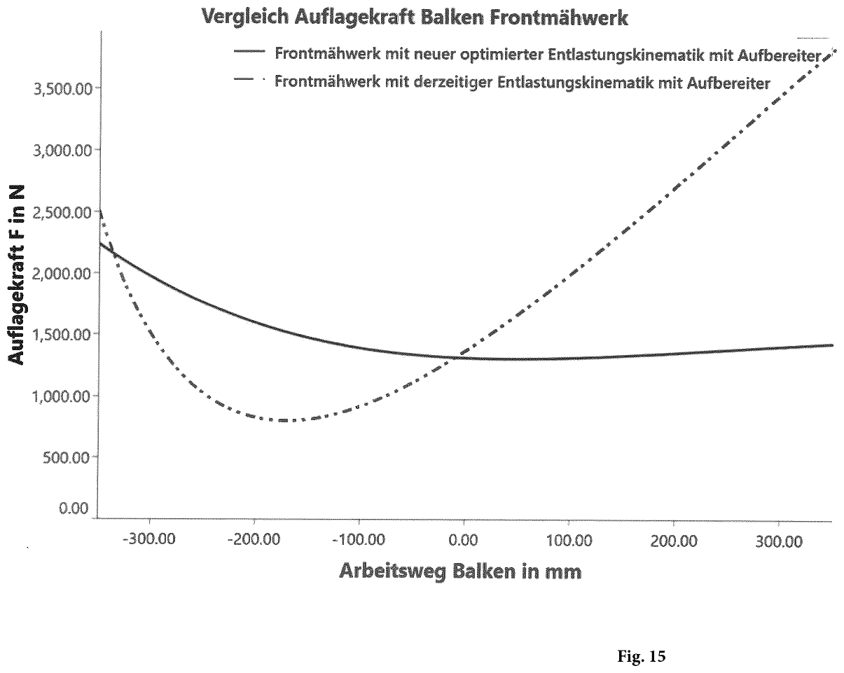

FIG. 15 shows a further comparison, in each case for a working assembly in the form of a mower with a supplementary conditioner, wherein here too the solid line shows an at least approximately constant ground contact force with a slight increase towards the lowered position. The dashed line, on the other hand, shows the strong change in the ground contact force for a state-of-the-art device, which initially shows a relatively stronger drop in the ground contact force during downward movements and then a stronger increase again. In addition, the ground contact force increases significantly during excavation movements, for example when driving up hills, cf. the dashed line on the right-hand edge of FIG. 15.

As shown in FIGS. 3 and 5 to 7, the force transmitter 22 can form an acute angle α with the upper steering arm 11 of the first steering assembly 10 for all height positions of the suspension 9, which can be <45° or even <30° for all height positions.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. An agricultural implement comprising:
a working assembly configured to be vertically movable through height positions and guided over ground during a work operation; and
a suspension configured to suspend the working assembly;
wherein:
the suspension comprises:
a headstock configured to be attached to a tractor or a frame connected to the tractor;
a first steering assembly that protrudes from the headstock and forms a four-bar linkage that is pivotably mounted to the headstock at a first joint and at a second joint;
a second steering assembly to which the working assembly is attached; and
a relief device configured for weight relief of the working assembly;
the relief device comprises a variable-length force transmitter configured to elongate/shorten; and
the force transmitter is of variable-length via being under pressure in such a manner that the force transmitter shortens when the first steering assembly is lowered and a lever arm of the force transmitter is reduced with respect to the four-bar linkage formed by the first steering assembly.

2. The agricultural implement according to claim 1, wherein the force transmitter:
is located between an upper steering arm of the first steering assembly pivotably mounted to the headstock at the first joint and a lower steering arm of the first steering assembly pivotably mounted to the headstock at the second joint; and
has a pivot point relative the headstock at a third joint that lies between the first joint and the second joint.

3. The agricultural implement according to claim 1, wherein the force transmitter and the first steering assembly are configured and arranged in such a manner that the relief device provides:
at least approximately constant weight relief over a height adjustment region of the suspension; and/or
a ground contact force of the working assembly that remains at least approximately constant over the height adjustment region of the suspension.

4. The agricultural implement according to claim 1, wherein the second steering assembly comprises a central carrier steering arm that at one end is articulated to the working assembly and, at another end, is articulated to a protruding end portion of the first steering assembly.

5. The agricultural implement according to claim 1, wherein the force transmitter is supported at one end in an articulated manner to the headstock and at another end in the region of a fourth joint on a protruding end portion of the first steering assembly.

6. The agricultural implement according to claim 1, wherein:
the force transmitter and an upper steering arm of the first steering assembly together form a two-position linkage articulated to the headstock at the first joint and a third joint that lies between the first joint and the second joint; and
the force transmitter and the upper steering arm are inclined to one another at an acute angle α of <45° in each of the height positions of the suspension.

7. The agricultural implement according to claim 1, wherein the first steering assembly forms at least approximately a trapezoidal steering arrangement.

8. The agricultural implement according to claim 1, wherein the second steering assembly forms a three-point steering arrangement that suspends the working assembly from a protruding end portion of the first steering assembly.

9. The agricultural implement according to claim 1, wherein the second steering assembly is configured to be spatially movable and provide for spatially pivoting movements of the working assembly relative to the first steering assembly about a horizontal pivoting axis pointing in a direction of travel and/or about an upright pivoting axis.

10. The agricultural implement according to claim 1, wherein the force transmitter comprises a pressure medium cylinder that is pressurized from two or more differently configured pressure accumulators connected in series or in parallel in such a manner that a different pressure is switched to the pressure medium cylinder in different longitudinal positions of the pressure medium cylinder.

11. The agricultural implement according to claim 1, wherein the force transmitter comprises at least one suspension strut having differently configured springs that are active in different length position regions of the suspension strut.

12. The agricultural implement according to claim 2, wherein the force transmitter has a force transmitter length that is smaller than both a length of the upper steering arm and a length of the lower steering arm.

13. The agricultural implement according to claim 3, wherein the geometries of the first steering assembly and the force transmitter are matched to one another in such a manner that a progression of a force provided by the force transmitter over its elongation/shortening is at least approximately a mirror-image to a change in the lever arm, which the force transmitter has with respect to the four-bar linkage formed by the first steering assembly, over a pivot path of the four-bar linkage, which is associated with the elongation/shortening of the force transmitter.

14. The agricultural implement according to claim 4, wherein the second steering assembly further comprises two lateral control steering arms that at one end are articulated in a spaced apart manner to the working assembly and, at another end, are articulated to the protruding end portion of the first steering assembly.

15. The agricultural implement according to claim 14, wherein:
the central carrier steering arm and the two lateral control steering arms are each hingedly attached to the working assembly and on the protruding end portion of the first steering assembly; and
the central carrier steering arm and the two lateral control steering arms are arranged in such a manner that the working assembly is configured to be luffed up from a horizontal neutral position about a horizontal axis pointing in a direction of travel relative to the first steering assembly and/or configured to be moved up and down with right and left end portions in opposite directions to one another.

16. The agricultural implement according to claim 15, wherein:
the second steering assembly is configured in such a manner that the working assembly can be moved up and down with lateral, right and left end portions in opposite directions and at the same time can be moved forwards and backwards in opposite directions in the direction of travel; and
an upward movement at a lateral end portion of the second steering assembly is associated with a backward movement against the direction of travel of the lateral end portion relative to the first steering assembly.
